(19) United States
(12) Patent Application Publication
(10) Pub. No.: US 2010/0325491 A1
(43) Pub. Date: Dec. 23, 2010

(54) MINING A USE CASE MODEL BY ANALYZING ITS DESCRIPTION IN PLAIN LANGUAGE AND ANALYZING TEXTURAL USE CASE MODELS TO IDENTIFY MODELING ERRORS

(75) Inventors: Nedumaran P. Kumanan, Hawthorne, NY (US); Amitkumar M. Paradkar, Hawthorne, NY (US); Avik Sinha, Hawthorne, NY (US); Stanley M. Sutton, Hawthorne, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/487,461

(22) Filed: Jun. 18, 2009

(51) Int. Cl. G06F 11/36; G06F 11/00

(52) U.S. Cl. 714/38; 703/22; 714/E11.208

(57) ABSTRACT

A system and method for identifying modeling errors in textual use case description analyze an input text describing a use case and create an application model representing the use case, the application model containing information obtained from analyzing the input text describing the use case. The application model may be automatically analyzed using automatic process and one or more errors in the use case and/or reports about the use case may be generated. In one aspect, processing components may be integrated into a user development environment to allow developing use cases and improving them incrementally and/or iteratively as information is identified about the use cases.

### BACKGROUND

The present application relates generally to application modeling, and more particularly to analyzing textual description of a use case and building a use case model. The present application also relates to analyzing the use case model and identifying errors or potential problems in the use case.

Graphical use cases along with their textual specifications are frequently used to model functional requirements of software applications. As such, use cases form basis for verification and validation activities such as consistency and completeness analysis and test generation. These analyses require manual extraction of a formal behavioral model from use case description. The manner in which the formal behavioral model is described varies widely. Some describe using notations such as sequence or activity diagrams. Others use a restricted subset of natural language, while yet others propose a multi-tiered representation combining restricted subset of natural language with a formal notation such as PetriNets or predicate logic. However, industrial use cases are primarily authored by non-technical business analysts who may not be skilled in the application of formal notations and also may not be comfortable in using a restricted natural language subset. Both these factors pose impediments to industrial adoption of such approaches. An approach which exploits a free-form natural language textual description is needed to overcome the high entry barrier in practice.

Modeling errors are one of the major sources for software bugs. During requirements specification stage of the software development, modeling errors creep into the specification, for example, via ambiguities, under specifications and inconsistencies. Modeling errors are usually identified after the fact or via post-mortem of the specification. If an analysis technique is able to detect the modeling errors as and when they are modeled, modelers may save a lot of time by providing in place correction for the errors.

### BRIEF SUMMARY

A system and method for identifying modeling errors in textual use case description are provided. The method, in one aspect, may comprise analyzing an input text describing a use case and creating an application model representing the use case. The application model, for instance, include information obtained from analyzing the input text describing the use case.

The method may also include analyzing the application model. The method may further include identifying one or more errors occurring in the input text in response to results obtained in the analyzing step. The method may also include repeating the steps of analyzing an input text, creating an Application model, analyzing the application model, and identifying one or more errors, in response to receiving one or more updates to the input text. Still yet, the method may include creating a report summarizing the information in the application model.

A system for identifying modeling errors in textual use case description, in one aspect, may comprise a text analysis module operable to analyze an input text describing a use case and further operable to create an application model representing the use case. The system may further include a model analyzer module operable to analyze the Application model and identify one or more errors in the use case.

A program storage device readable by a machine, tangibly embodying a program of instructions executable by the machine to perform methods described herein may be also provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates an example of the process of use-case authoring and refinement according to one embodiment of the system and method of the present disclosure.

FIG. 2 displays a screenshot of the UDE in one embodiment of the system and method present disclosure.

FIG. 3 illustrates an application model using the UML class diagram notation in one embodiment of the present disclosure invention.

FIG. 4 illustrates an overview of the functional components of the text analysis engine in one embodiment of the present disclosure.

FIG. 5 illustrates examples of annotations posted by the shallow parser

FIG. 6 is a flow diagram summarizing a method of analyzing plain language description of a use case in one embodiment of the present disclosure.

FIG. 7 illustrates an overview of a part of the system of the present disclosure in one embodiment that addresses model analysis.

FIG. 8 illustrates an overview of the operations performed during model analysis in one embodiment.

FIG. 9 is diagram that summarizes functional components in one embodiment of the system of the present disclosure and shows aspects that pertain to iterative refinement of textual use-case descriptions.

FIG. 10 illustrates an example of interactive method employed for iterative refinement of use case description.

FIG. 11 illustrates an example of a computer system, in which the systems and methodologies of the present disclosure may be carried out or executed.

### DETAILED DESCRIPTION

We present a method and a system for authoring and refining natural-language descriptions of use cases. A use case describes the behavior of a system in terms of interactions between the system and a user, as seen from the user's perspective. Describing software requirements via use cases is a technique used in the current software industry, for example, among business analysts and requirement analysts. Use cases are captured very early in the software life-cycle, usually in interaction with the customer. Subsequently, they are input to a variety of software engineering activities, such as requirements validation and test creation. In practice, along with the stick figures and ovals used in a graphical representation, many aspects of a use case are described in natural language (NL) text.

Because use cases are defined early in the software life cycle, and because many other artifacts in the life cycle depend directly or indirectly on use cases, the quality of use cases need to be maintained for the overall quality of a software product. Since many aspects of a use case are described in NL text, the quality of these texts should be maintained.

However, the authoring of high-quality use cases texts can be difficult. For instance, authors may not be experienced in the writing of use cases, authors may not be fully cognizant of rules governing use-case style and content, these rules may vary from project to project and from organization to organization, and authors may not know how use cases will be used in subsequent development activities—or even in which activities use cases will be used.

In one aspect, the method and system disclosed herein address those difficulties, for example, by supporting use case authoring and refinement by the analysis, modeling, and evaluation of NL use case texts.

A method of the present disclosure in one embodiment may include writing new NL use-case texts or editing existing NL use-case texts; and analyzing the NL use-case texts and creating an “application model” representing the information in the texts. The method may also include analyzing the “application model” and identifying errors and their occurrence in the texts. The method may further include providing feedback to the user corresponding to the errors found. The method may yet also include repeating the above steps in response to feedback about errors or for other reasons, for example, so as to iteratively improve the quality of the NL use-case texts, for example, and incrementally.

A system of the present disclosure in one embodiment may include a facility for storing, displaying, editing use-case texts. The system may also include a facility for analyzing use-case texts written in natural language. The system may further include a data schema for representing an “application model”. The data schema for representing an “application model” may include a data schema for representing a “use-case model”. The data schema for representing an “application model” may also include a data schema for a “context model” that represents information about the general context in which use cases are assumed or inferred to occur, such as information about the actors, system, and entities involved in the use cases.

The data schema for representing a “use-case model” may include a data schema for a “use-case description,” representing information about an individual use-case text, including textual elements, the organization and relationships of textual elements, linguistic properties of the text, and other properties of the text. The data schema for representing a “use-case model” may also include a data schema for a collection of models of use cases represented as use-case descriptions.

The system of the present disclosure in one embodiment may also include facilities for constructing and accessing instances of the above data schemas, that is, instances of application models. The system of the present disclosure in one embodiment may further include a facility for constructing instances of the above schemas (that is, for constructing application models) based on the analysis of use-case texts written in natural language. The system of the present disclosure in one embodiment may also include a facility for analyzing instances of the above schemas (that is, for analyzing application models) so as to identify problems and other features of interest. The system of the present disclosure in one embodiment may yet further include a facility for reporting the results of analyses of instances of the above schemas (that is, for reporting results of the analyses of application models), for example, so as to provide feedback to the authors of the use-case texts on the nature and occurrence of problems and other features of interest. The method and system and their support for use-case authoring and refinement are described more in detail in the following sections.

### The Use Case Authoring Process

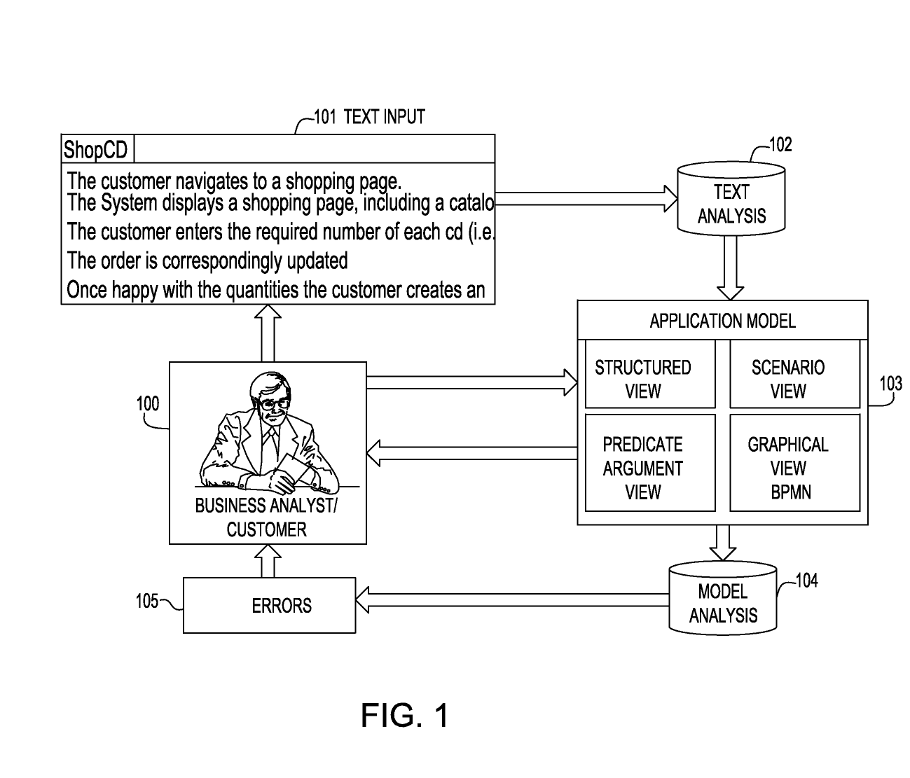

In one embodiment, the method and system presented in this disclosure support the process of authoring and refining natural-language descriptions of use cases. FIG. 1 illustrates an example of the process of use-case authoring and refinement according to one embodiment of the system and method of the present disclosure.

The author in the example is a Business Analyst (BA). One of the roles of the Business Analyst in the software development life cycle is to capture customer intent for the system under development by specifying use cases in an unambiguous and consistent manner. It is noted, that the use of the system and method of the present disclosure is not restricted to Business Analysts or to persons acting in that role. In performing the process, the Business Analyst makes use of an integrated use-case development environment (UDE). A UDE is one example of an embodiment of a system of the present disclosure. An example implementation of a UDE may include the facilities for constructing and analyzing textual use cases described above, and other facilities for working with use cases, such as views of use cases and tools for deriving additional software artifacts based on use cases.

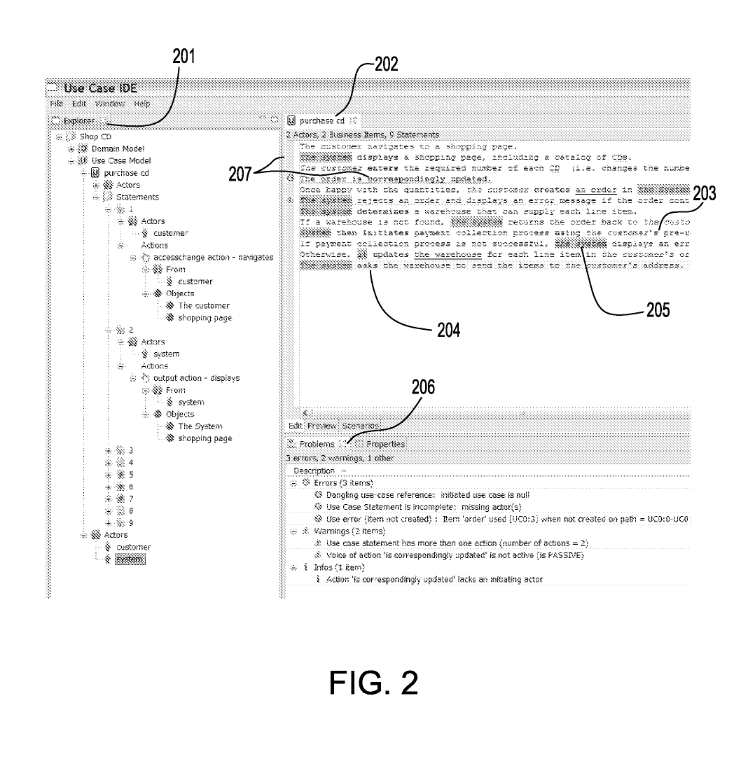

As shown in FIG. 1, using the UDE, a BA (100) or any other author of a use case can create its description in plain text (101). The UDE is supported by a text analysis engine technique of the present disclosure in one embodiment. The text analysis (102) engine processes the textual information to create the application model (103) representing the information in the use cases. The application model (103) may include models of use-case text, models of collections of use cases, and models of the general context of use cases. The application model of the use cases may be then displayed to the author in multiple views, for example, including, but not limited to, a structured outline view of the use case description (UCD); a predicate argument view for sentences in the UCD; a scenario view; and a graphical control flow view using the Business Process Modeling Notation. The Business Process Modeling Notation is described at URL, “http://www.bpmn.org/”. Briefly, a predicate argument view may be a view such as the explorer view illustrated in FIG. 2 at 201. A scenario view may show different or multiple scenarios found in the use case text in different panels of a user interface screen. A structured outline view may show outlined or grouped elements found in the use case text.

The model and its views may be subject to review by the author for correctness and completeness. The model may be then input to the Model Analysis component (104), which computes a set of errors and other information (105). The errors and other information may be reported to the BA (100). The BA may then choose to ignore the errors or to edit the text so as to fix the errors. If the BA chooses to fix the errors, then the process shown at 102 to 105 may be repeated in order to validate the fixes and to check for new errors. In one embodiment, for example, the whole cycle (100-105) may be repeated until all errors (or all errors desired to be removed) are removed.

FIG. 2 displays a screenshot of the UDE in one embodiment of the system and method present disclosure. A user (e.g., 100 in FIG. 1) may enter the text or textual description of a use case in plain language, for instance, English or another language, via the editor panel (202). In response to saving of the entered text or in response to an explicit command, the natural-language text analysis may be invoked (e.g., automatically) and the extracted application model may be displayed (e.g., automatically) on the “Explorer” panel (201). FIG. 2 at 201 shows one example representation of a use case model. Selected elements (e.g., main elements or those deemed to be important) in the use-case text may be highlighted in various ways. For example, actors in the main text are italicized (203) and main actions are bolded (204). The model elements may be also hyperlinked to the same or other elements. For example, selecting a particular model element highlights (205) its occurrences in the text. The model analysis can be invoked automatically upon completion of the text analysis or by a user command at any point once the text analysis is complete. If the model analysis detects any problems or other significant or selected conditions in the model, feedbacks on these problems or conditions may be displayed in the “Problems” panel (206). In one embodiment, the feedbacks may be categorized according to their severity. The input text may be also marked corresponding to the individual feedbacks using various annotations (207) in the editor panel (202).

### Application Model

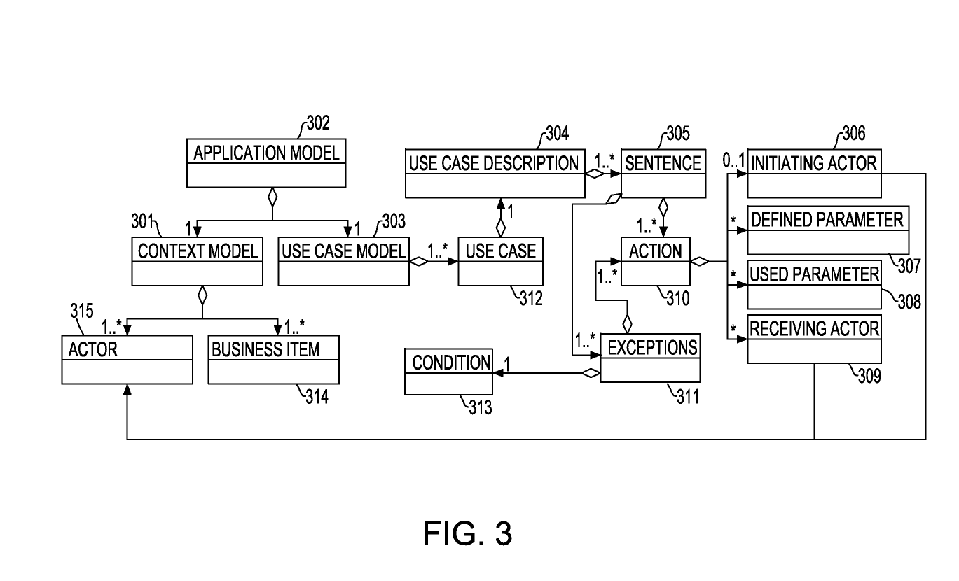

The information in the textual description of use cases is extracted by the text analysis engine to create a computer model which we refer to as “application model.” The application model represents information obtained from the textual descriptions such as information on individual use-case texts, information on collections of use cases, and information on the context of use cases. FIG. 3 illustrates an application model using the UML class diagram notation in one embodiment of the present disclosure invention. Details of UML can be found at the URL “http://www.uml.org/”. It should be understood that the system and method of the present disclosure is not limited in any way by the illustrated application model and its structure described below. Rather, the illustration is shown as an example embodiment only for ease of explanation. Thus, other structures and definition may be created and used as application model. FIG. 3 illustrates one example of representing a use case model.

As an example, the application model (302) may include two models: the “Context Model” (301) that models context of the use case process; and the “Use Case Model” (303) that models the process described in use cases. The “Context Model” (301) contains information about the “Business Items” (314) and the “Actors” (315) that participate in the use cases. The “Use Case Model” (303) contains a collection of “Use Case” (312). Each “Use Case” (312) has a “Use Case Description” (304) that contains a sequence of “Sentences” (305). A “Sentence” (305) is a collection of “Actions” (310). The “Application Model” (302) may contain the classification of actions and also other information about them such as the “Used Parameters” (308), the “Defined Parameters” (307), the “Initiating Actor” (306) and the “Receiving Actor” (309). An “Exception” (311) can be associated with a “Sentence” (305). The “Exception” (311) describes the alternate behavior that should replace the behavior described in the associated “Sentence” (305) if the “Condition” (313) is true.

### The Analysis of NL Text and Generation of Application Model

The analysis engine for analyzing of text description of a model, also referred to herein as the text analytics engine, disclosed in the present disclosure in one embodiment creates the application model using the textual use case descriptions (UCDs).

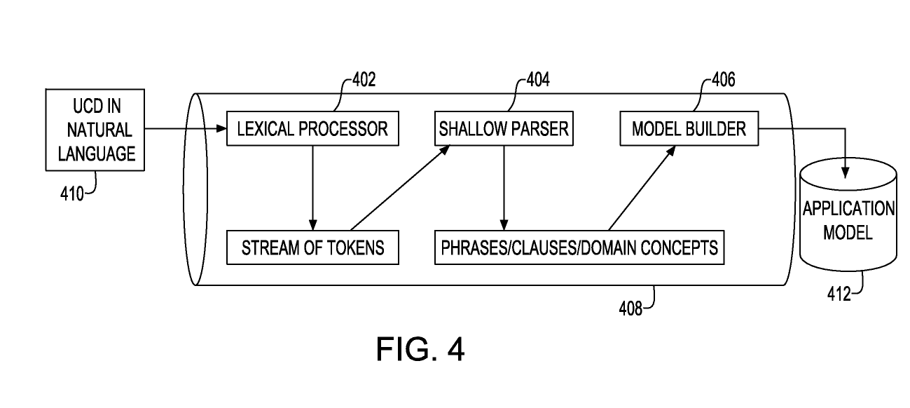

FIG. 4 illustrates an overview of the functional components of the text analysis engine in one embodiment of the present disclosure. FIG. 4 shows lexical processor 402, shallow parser 404 and model builder 406 integrated in the analytics engine 408. UCD in natural language 410 is input to the Engine 408 and the engine produces an application model 412.

To illustrate the functions of the components shown in FIG. 4, we use the following textual use-case description (in this example, “PAF” is the name of the computer application under development):
“A purchaser selects to buy stocks over the web. PAF gets name of the web site to use (E*Trade, Schwab, etc.) from user. The Open Connection Use Case executes with the name of the website. Stocks are bought from intercepts responses from the web site and updates the purchaser's portfolio. If the stocks are not available, PAF outputs an error message. PAF shows the purchaser the new portfolio standing.”

In one embodiment, a lexical processor 402 provides following services (collectively referred to as Lexical Services), although not limited those: Tokenization, Lemmatization and Morpho-syntactic analysis. Tokenization service in one aspect includes breaking text into words and/or punctuation marks. Lemmatization determines the base form of a word. Morpho-syntactic analysis associates lemma forms with contextually appropriate part-of-speech information. The lexical processor 402 in one aspect provides lexical services, which are not limited to a single application or domain. The lexical processor 402 may embody lexical knowledge of unconstrained English and over a hundred other languages. This ability facilitates adaptation of the system to different domains.

The output of the lexical processor 402 is a stream of tokens as follows. A token's starting point is denoted by ‘[’ and its end is denoted by ‘]’; the part-of-speech (POS) and the lemmatized form is shown in parentheses following the closing square bracket.
[A] (determiner, a) [purchaser] (noun, purchaser) [selects] (verb, select) [to] (preposition, to) [buy] (verb, buy) [stocks] (plural noun, stock) [over] (preposition, over) [the] (determiner, the) [web] (noun, web) . . . .

Shallow parsing component or shallow parser 404 may be a general purpose parsing component that acts as a syntactic analysis system for the identification of phrasal, configurational, and grammatical information in free text documents. The shallow parser 404 may include a cascade of finite-state transducers (FSTs), for example, a dozen finite-state transducers (FSTs). An FST looks for patterns in the text and records its finding by marking up the text. For instance, an example FST can scan the text for series of tokens that are nouns. Once it finds a series of “nouns”, it marks them up as a “noun group”. Subsequently, another FST can look for patterns of “noun groups” followed by “verbs” and mark the “verbs” as actions. In one aspect, the cascade adopts a non-recursive model of language, and layers finite state transducers. At the lowest level of the cascade are simple noun and verb group grammars; the higher levels seek to build complex phrases, identify clause boundaries, construct predicate-argument clusters, and mark grammatical function. The shallow parser annotates the text to record its findings. Following is a comprehensive list of concepts found by the shallow parser.

Phrases: noun phrase, e.g., “the new portfolio standing”; adjective phrase, e.g., “too long”; coordinating noun phrase, e.g., “the participating employee, John Smith”; noun phrase list, e.g., “account id, password and the amount”; prepositional phrase, e.g., “to the customer”; possessive noun phrase, e.g., “the customer's address”; verb group, e.g., “creates and updates”; passive verb group, e.g., “is notified”.

Clauses: subordinate clause, e.g., “If there are no exceptions, the application . . . ”; infinitive clause, e.g., “Actor clicks the OK button to buy stocks over the web.”; modifying clause, e.g., “System shows a message showing success”; wh-clause, e.g., “The customer, who is already authorized, enters . . . ”. Grammatical Function: subject, the subject of an active voice sentence; passive subject, the subject of a passive voice sentence; and object, the object of some action.

The shallow parser component goes beyond simple “chunking” of tokens. The parser 404 performs configurational analysis that supports the model generation process from UCD text. Being realized as cascaded FSTs, the analytics are compact, perspicuous, easy to modify and adaptable to idiosyncratic domains or languages other than English. The FST analysis is a UIMA analysis engine described further in B. Boguraev and M. Neff. An annotation-based finite state system for UIMA B. Boguraev and M. Neff. Navigating through dense annotation spaces. In Proceedings of the Sixth International Conference on Language Resources and Evaluation (LREC-2008). Marrakech, Morocco, May 2008, which is incorporated herein by reference in entirety. The shallow parser works by identifying first noun phrases, verb phrases and prepositional phrases. Next, it finds infinitive clauses, modifying clauses, subordinate clauses and Wh-clauses based on patterns of noun and verb phrases. Subsequently, it scans for phrase patterns with respect to clauses to identify subjects and objects in sentences.

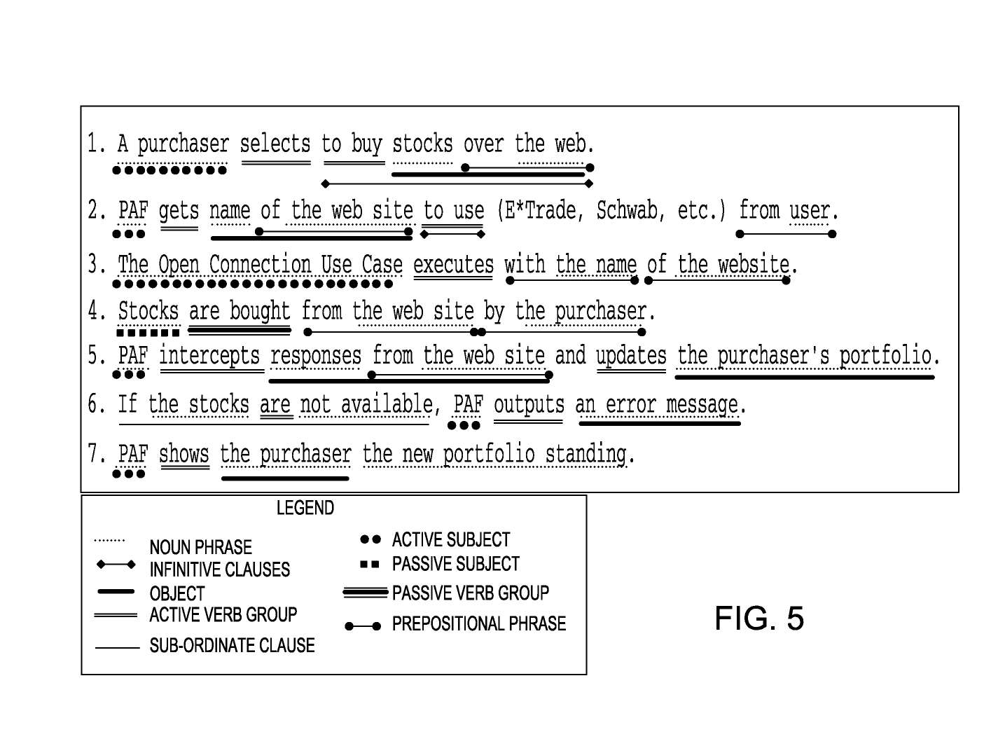

FIG. 5 shows the annotations posted by the shallow parser component on the above example text. It is an example of an output from the shallow parser. Notice that in sentence no. 2 of the example shown in FIG. 5, the annotation for the Object ends prematurely and covers only the text “name of the web site”, instead of also including the text “to use(E*Trade, Schwab, etc.)”. This exemplifies how the parser component tolerates noise. Despite the orthographically conspicuous token “E*Trade,” the parser recognizes correctly all the phrases, and partially annotates the Object.

The model builder 406 in one embodiment extracts a UCD model using the annotations posted by the shallow parser on the UCD text. For instance, the model builder 406 may apply one or more heuristics on the output or annotations shown in FIG. 5 to create an application model. For semantic classification of verbs and nouns, the model builder 406 uses a domain dictionary in one embodiment. The domain dictionary is an extensible and eternalize-able knowledge base that contains a compilation of commonly occurring nouns and verbs in UCDs. The nouns and the verbs are grouped into semantically equivalent classes from the point of view of the UCD model. For instance, consider the following sentences: “System displays the result. System writes the result.” In the context of UCDs the verbs “display” and “write” are equivalent as they both imply “system outputting the result”. Similarly, the nouns “array”, “bag”, “catalog”, “collection”, “directory”, “group”, “inventory”, “list”, “listing”, “selections” and “set”, constitute the semantic class of noun “Collection”. While synonyms of a verb and/or noun always belong to the same semantic class, all entries in a semantic class are not necessarily synonyms.

The model builder 406 builds the model via a series of scans of the annotated text and by use of heuristic rules as described below. The heuristic rules assume that each relevant sentence in a UCD is describing one or more actions by an agent in accordance with a UCD meta-model, for example, shown in FIG. 3.

During its scan (e.g., its first scan), the model builder 406 extracts actors from the “subject” annotations in active voice sentences according to the following heuristic rules in one embodiment.

Rule 1: A noun phrase within a “subject” of an active voice sentence will always represent either an actor, or the system, or use case.

Consider the “subject” annotations in FIG. 5. According to rule 1 “purchaser”, “PAF” and “Open Connection Use Case” are either “actors”, “system” or “use case”. From these initial candidates, the model builder 406 identifies the actors by a process of elimination. The subject phrases that represent the system are eliminated the first. A “system” actor can either be discovered by use of the domain dictionary—if the included noun phrase has nouns that are semantically equivalent to the noun “system”—or in accordance to the following heuristic in one embodiment.

Rule 2: If a “subject” is associated with an action of type “output”, then it can only represent the system.

Sentence no. 7 in the example UCD in FIG. 5, the noun-phrase “PAF” is performing the action “show” which is semantically equivalent to “output”. Using rule 2, “PAF” is identified as a noun representing “the system”. The subject phrases that represent other or included use cases are similarly eliminated either by using the domain dictionary or in accordance to the following heuristic rule.

Rule 3: If a “subject” is associated with an action of type “execute”, then it can either represent a system or a use case.

Thus, by the use of the domain dictionary and using the rules 1, 2 and 3 one can identify the actors of the example UCD as “Purchaser”.

During another scan (e.g., its second scan), the model builder 406 extracts actions in a UCD. The model builder 406 scans each sentence of the annotated text for annotations: “verb group”, “object”, “noun-phrase”, “prepositional phrase”, “sub-ordinate clauses” and “infinitive clause”; and fills in the elements of an action viz., the defined parameters, used parameters, exceptions, initiating actors and receiving actors, for example, according to the model as shown in FIG. 3.

The model builder 406 may apply the following additional rules to build an application model from the annotated text, for example, as shown in FIG. 5.

Rule 4: In an active voice sentence, when a “verb group” is immediately followed by an object”, the action is denoted by the verb(s) in the precedent while a “noun phrase” within the latter denotes either a parameter or an actor.

Rule 5: In a passive voice sentence, when a “subject” is immediately followed by a “verb group” then the verb(s) in the verb group denote action while the nouns in the precedent can either denote a parameter or an actor.

Rule 6: When a “verb group” immediately precedes an “infinitive clause” or has just an “object” in between them, the verb(s) in the “verb group” is the action while the “verb group” within the “infinitive clause” concatenated to its parameter represent the parameter.

Rule 7: If a non subject “noun phrase” immediately follows an “object” that has an immediately preceding “verb group”, and if the “object” represents an actor, then the “noun phrase” is a parameter for the action obtained from the “verb group”.

For example, consider the effect of Rule 6, in sentence no. 1 in FIG. 5. The model builder 406 picks “select” instead of “buy” as the action. The “verb group” within the “infinitive clause” concatenated with its parameter forms the parameter of “select” action. Further, in sentence no. 3 in FIG. 5, according to Rule 3 it interprets a call to “open connection use case”. Also, while interpreting sentence no. 7, the model builder knows that “purchaser” is an actor (e.g., from the previous or first scan). Thus, using rules 4 and 7, it relates the action “show” to the parameter, “the new portfolio standing”.

In one embodiment, the model builder 306 may use the domain dictionary to classify the parameters into used and defined parameters. The semantically equivalent verb classes in the domain dictionary are broadly classified into defining actions, e.g., Create, Write and Update; utilizing actions, e.g., Read, Receive; transactional actions, e.g., Browse, Allow; and descriptive actions, e.g., Contain, Exist. The classification above is on semantic classes of verbs and not on individual verbs.

Rule 8: A parameter to a defining action is a defined parameter and that to a utilizing action or a descriptive action is a used parameter.

Transactional actions usually are followed by prepositional phrases, e.g., Actor browses to the stock purchase page. The heuristic rules for prepositional phrases determine the used and defined parameters for such actions.

Occasionally a use case description may contain conditional sentences, like the 6th sentence in the example shown in FIG. 5. The model builder 306 may treat such sentences as exceptions and build the model using the following heuristic:

Rule 9: If a sub-ordinate clause starts with a subordinate conjunction that indicates a condition, e.g., “If”, “Until”, and “While”, and it is followed by an action, then the latter is added as an action to an exception block. The subordinate clause is added as the “condition” for the exception.

Following Rule 9, the model builder 306 may add an exception to the actions “Updates” and “intercepts” of statement 5. In its third scan, the model builder 306 relates actors and additional parameters to the action-parameter groups identified during the second scan. During this step, the configurational information produced during the shallow parser is used for relating initiating actors to the action parameter groups. The “subject” and “prepositional phrases” may be evaluated sentence by sentence according to the following rules:

Rule 10: If in an active voice sentence, the “subject” represents an actor, precedes the action and is closer than any other preceding “subject phrase”-s, then it denotes the initiating actor.

Rule 11: If in a passive voice sentence, the “prepositional phrase” has “by” as its leading preposition and it is closer in following the action than any other “prepositional phrase” with a “by”, then it denotes the initiating actor.

In one aspect, the rules uniformly apply for simple, compound and complex sentences. The scoping is guided by the proximity of the “subject” to the action-parameter groups and the voice of the action.

A prepositional phrase includes a leading preposition and a trailing “noun phrase”. The model builder 406 adds parameters or secondary actors to an action-parameter group using the trailing “noun phrase”. The model builder 406 determines the relation between the trailing “noun phrase” and the action-parameter group based on: (a) the leading preposition, (b) the classification of the action, (c) the voice of the action and (d) if the trailing noun phrase is an actor or not. The rules are not limited to those shown herein. Other rules may apply.

More examples of the rules are listed below.

Rule 12: If the trailing noun is an actor, and the preposition indicates the trailing noun as a recipient of the effect of the action (e.g., to, for) then the noun phrase is marked as the receiving actor to the related action.

Rule 13: If the trailing noun is not an actor and if the preposition indicates usage of the trailing noun (e.g., via, with, through) then the trailing noun is included as a used parameter to the related action.

For instance, consider again the sentence no. 3 in the text example. Using Rule 13 the model builder 306 determines that “The Open Connection Use Case” is invoked with the parameter representing “name of the web site”.

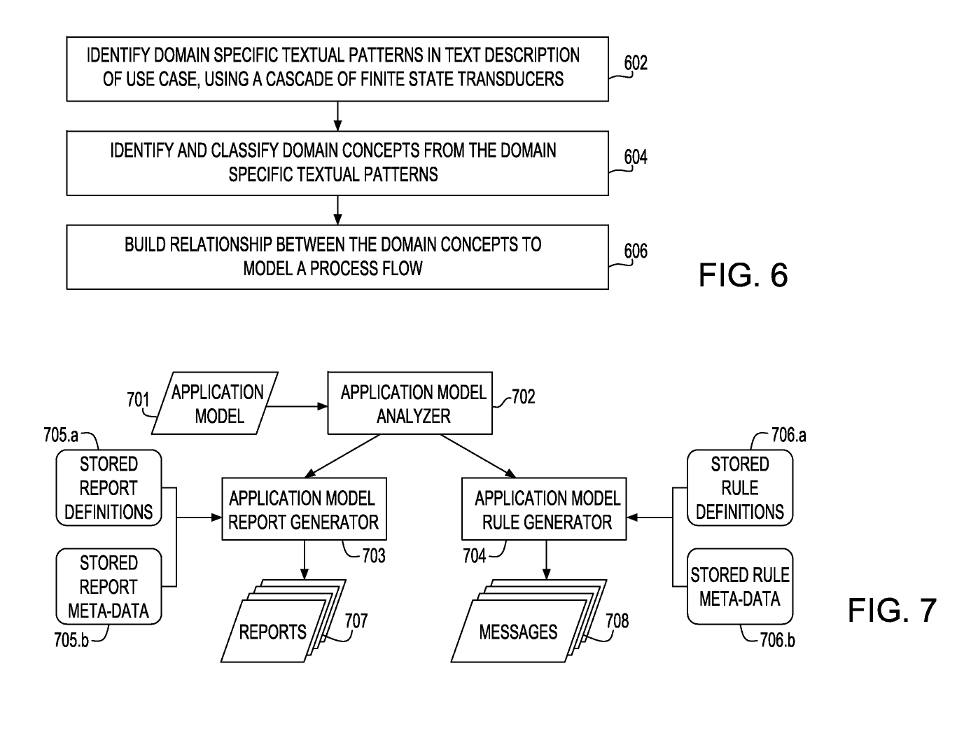

FIG. 6 is a flow diagram summarizing a method of analyzing plain language description of a use case in one embodiment of the present disclosure. At 602, the elements of UCD model are identified. For example, actions are identified based on verb phrases that follow subjects in a UCD sentence. Also actors are identified based on subjects in UCD sentences and rules 1, 2 and 3. At 604, the identified actions are classified, e.g., based on a domain dictionary. Actions are classified into defining actions, e.g., Create, Write and Update; utilizing actions, e.g., Read, Receive; transactional actions, e.g., Browse, Allow; and descriptive actions. e.g., Contain, Exist. At 606, relationships are built between the UCD model elements, for example, between the classified actions and actors, and further using predetermined heuristic rules. The relationship built is used to create a use case model, i.e., application model. In one aspect, the use case model is built in accordance with a meta-model preselected or predetermined, for example, as shown in FIG. 3. Optionally, the resulting use case model may be manually modified by the user.

### Model Analysis

Analysis of an application model is performed to obtain information about the model and the underlying use case text that it represents. In turn that information may be used to guide, constrain, or contribute to subsequent development activities of various sorts.

In general, analyses may take two different forms: reports and rules (rules are also known as predicates), but not limited to only those two forms. Reports produce arbitrary output, typically text in some form. They may embody an arbitrary computation; these are presumed to be focused on an application model but are not restricted to that. Reports are intended for information that may summarize a model or describe many collective elements in detail. Examples would be the collection of metrics or the gathering of data on the occurrence of errors.

Predicates produce a Boolean (True/False) result. Like reports, predicates may embody arbitrary calculations that are presumed to be focused on an application model but are not restricted to that. Additionally, a predicate applies to a particular model element, which is its principal argument, and its result can be associated with that element. Additionally, predicates can be assigned a severity level and interpreted as indicators of errors or other notable conditions. So, for example, a predicate may test whether as sentence has more than one action, violation of which may yield a warning, or it may test whether a reference to a use case is defined, violation of which may yield an error.

The system and method of the present disclosure in general impose no restrictions on the analyses performed. In one embodiment, we have implemented several types of predicates, some of which exemplify commonly accepted standards for use case style and content, and some of which are of particular interest in relation to subsequent software-development activities such, as test-case generation. Some examples of these conditions are:
Stylistic checks for English sentences e.g., voice, use of actions of recognized kinds, use of anaphora.
Complexity checks for the number of actors or actions in a statement, the number of updates to an item in a use case, and so on.
Completeness checks of use case statements e.g., missing actors and actions, missing parameters.
Structural checks for the model e.g., consistent use of aliases, dangling use case references.
Flow checks for data and the control flow e.g., analysis for consistencies such as attempts to use items before they are created.
Ownership checks that validate accessibility of data or appropriateness of actions relative to actors.
Path checks that validate accessibility of data from the point of view of use case scenarios and their sequences.
Concurrency-related checks, e.g., for the occurrence of possibly concurrent actions or possibly non-serializable behaviors.
Inter-model checks to compare the actors and items referenced in a use case to element in an associated domain model.

In another embodiment, we have implemented a report to provide information on control-flow paths through a collection of use cases. In yet another embodiment, we have implemented a report to provide summary statistics on the occurrences of errors (that is, rule violations) in a collection of use cases.

The system and method of the present disclosure in general impose no restrictions on the times at which the analyses are performed or the manner in which the analyses are invoked. In one embodiment, the analyses may be invoked automatically whenever the application model is modified. The analyses may be invoked manually whenever the user makes a request. In one embodiment, the evaluation of predicates or groups of predicates can be activated or deactivated at user discretion, thereby enabling analyses to be performed or not at appropriate times, regardless of the manner by which the analyses are invoked.

The system and method of the present disclosure in general impose no restrictions on the significance that is associated to the results of analysis. In one embodiment, reports may be printed to the console for user viewing without any additional commentary or direction, and any consequent action by the user is entirely at the user's discretion. In another embodiment, messages may be displayed in a user interface and graphical annotations may be made on a display of the use-case text (e.g., as shown in FIG. 2). These messages and annotations convey information about the severity of problems that are reported in the messages and signified by the annotations, for example, describing the problem and associating a severity level to the use case such as “error”, “warning”, or “info.” In this case the improvement in quality of the use case and the ability to use the use case in subsequent development activities may depend on correcting the reported problems. In one embodiment, the evaluation of particular predicates or groups of predicates can be activated or deactivated at user discretion, thereby enabling the performance of analyses that are deemed significant and disabling the performance of analyses that are deemed not significant. Additionally, the system and method of the present disclosure in general impose no restrictions on the significance of the results of analysis for subsequent software-development activities. In one embodiment, the results of analysis can be used to assess the suitability of a use-case description for manual requirements specification, for automated generation of use-case process models, or for automated generation of test cases, or for others.

FIG. 7 illustrates an overview of a part of the system of the present disclosure in one embodiment that addresses model analysis. The model analysis function (702) takes as input an application model (701). This, for example, is the same model as the application model (412) produced by the text analysis Engine (408) as shown in FIG. 4. The model analysis function (702) may include two main sub functions: report generation (703) and rule evaluation (704), although not limited to those two. The report generation function (703) takes as input stored report definitions (705.a) and stored report meta-data (705.b). The stored report meta-data (705.b) may include information about how to conduct and present the reports, for example, whether a specific report is to be generated or the formatting of generated reports. Reports may provide summary or information about the use case from analyzing the application model (701). The rule evaluation function (704) takes as input stored rule definitions (706.a) and rule meta-data (706.b). The rule meta-data (706.b) may include information about how to conduct and present the results of rule evaluation, for example, whether a specific rule is to be evaluated and the severity level assigned to a rule. The report generation function takes as input an application model (701), stored report definitions (705.a), and stored report meta-data (705.b) and produces as output generated reports (707). The rule evaluation function takes as input an application model (701), stored rule definitions (707.a), and stored rule meta-data (707.b) and produces as output error messages (709).

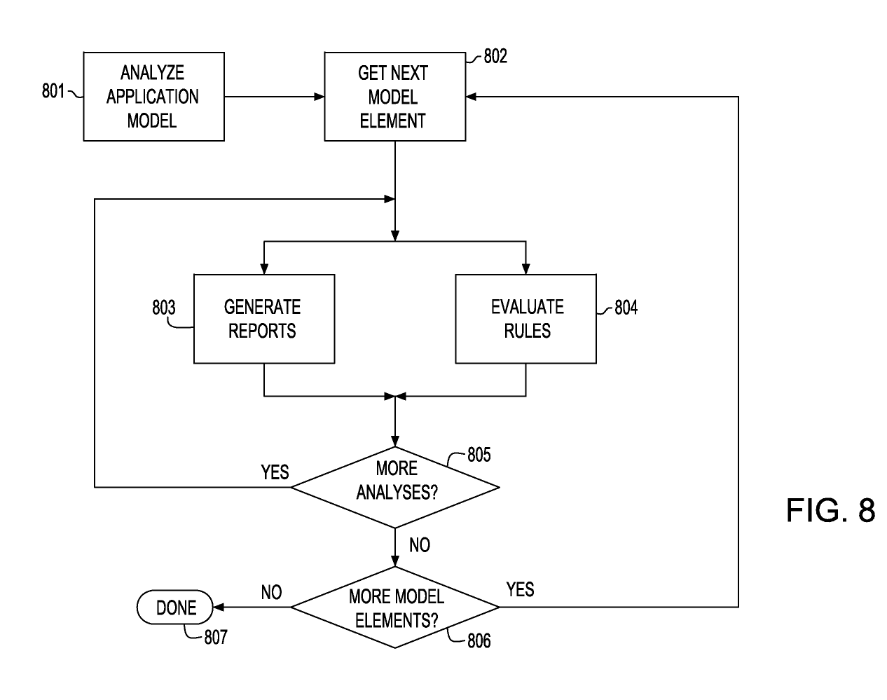

FIG. 8 illustrates an overview of the operations performed during model analysis in one embodiment. At the top level the function represented is Analyze Application Model (801). This function may be performed by the component Application Model Analyzer (702) shown in FIG. 7. The Analyze Application Model function (801) traverses the given Application Model (e.g., represented by 701 in FIG. 7), addressing each model element (802). In general the process does not require that the model elements be considered in any particular order, and it allows the model elements to be considered sequentially or in parallel. In one embodiment of the method of the present disclosure, we apply a recursive descent algorithm to visit and analyze the model elements in sequence. The method analyzes each model element using the applicable analyses, which may be accomplished by the activity Generate Reports (803) and/or the activity Evaluate Rules (804). These activities may be performed in sequence or in parallel or in an interleaved manner on any model element. In one embodiment of the method of the present disclosure, we evaluate rules sequentially for each model element and then generate reports sequentially for each model element. According to the method in one embodiment, the analyses are applied to each model element until all applicable analyses have been evaluated (805). Also according to the method, model elements are analyzed until all applicable analyses have been performed for all model elements (806). At that point the method is done (807).

### Iterative Refinement

Another aspect of the system and method of the present disclosure is the ability to iteratively refine textual use-case descriptions based on feedback provided by the natural-language analysis of textual use-case descriptions, construction of an application model of the use-case descriptions, and analysis of the application model, as described in the previous sections. This process can be applied repeatedly to decrease the amount of negative or critical feedback or to maximize the amount of positive or accepting feedback.

The system and method of the present disclosure do not impose any limitations on the number of iterations of refinement or on the goals of iterative refinement. For instance, iterative refinement may continue for a number of iterations that is prescribed by a development method, or until the use-case author is satisfied with the level of refinement, or until all of the analytical feedback on the use case is favorable, or until the analytical feedback related to selected rules is favorable, among other conditions. Similarly, iterative refinement may be directed to satisfy the preconditions for subsequent development activities, such as manual requirements specification or automated test generation. For instance, in one embodiment of the system and method of the present disclosure, iterative refinement may continue at the discretion of the use-case author, or until selected stylistic rules have been satisfied, or until the conditions necessary for generating test cases from the use cases have been met.

The system and method of the present disclosure likewise do not impose any restrictions on the length or pace of iterations. The length or pace of iterations may be at the discretion of the use-case author. Alternatively, the length or pace may be defined by the rules of a development method or by the requirements of a development project. Refinement may be performed without interruption between successive iterations or with interruptions between successive iterations. In one embodiment of the method, we leave the length and pacing of iterations up to the use-case author and iterations may be performed with or without interruption.

The system and method of the present disclosure further do not impose any restrictions on the temporal relationship between the iterative refinements of multiple use cases. That is, multiple use cases may be iteratively refined in a sequential manner (that is, finishing refinement for one use case before starting refinement of another), in an interleaved manner (that is, performing an iteration on one use case, then performing an iteration on another use case), or in a concurrent manner (that is, performing iterations on more than one use case at the same time). In one or more embodiments of the system and method of the present disclosure, all of these practices are possible.

The form of feedback provided is not restricted by the system and method of the present disclosure. For example, the feedback may take the form of reports or of error messages or of annotations. The form and representation of reports is not restricted by the system and method of the present disclosure and reports in general may take textual or graphical forms and may appear, for example, in an electronic display, or as stored electronic data, or in a hardcopy embodiment such as a paper document. The form and representation of error messages and annotations may be determined according to the requirements and use of the use-case development environment in which they appear and they may also be given the same representations and forms as reports. In one embodiment of the system and method of the present disclosure, we provide feedback in the form of textual reports printed to a computer console and error messages (202) and annotations (207) that are posted in a use-case development environment (as shown in FIG. 2).

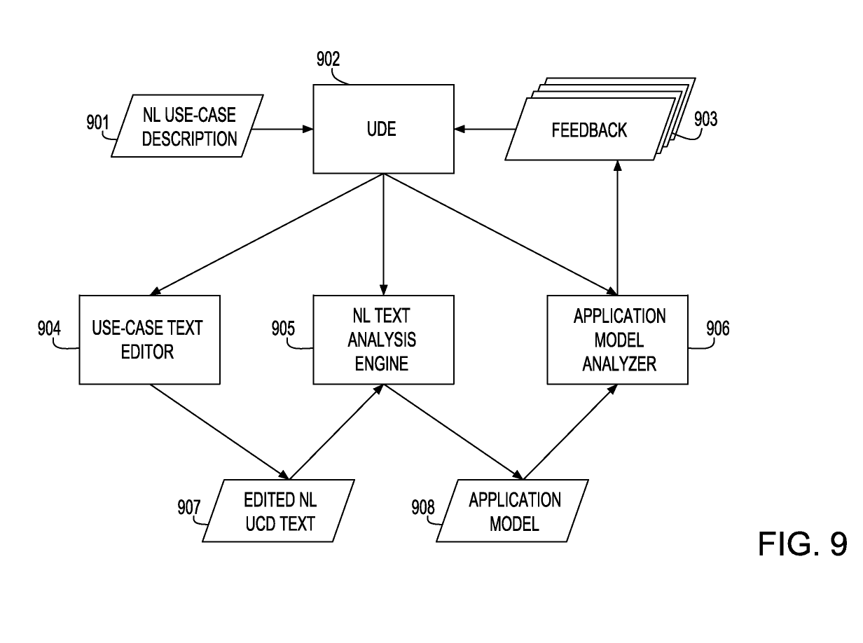

FIG. 9 is diagram that summarizes functional components in one embodiment of the system of the present disclosure and shows aspects that pertain to iterative refinement of textual use-case descriptions. The input to the system may be a natural-language (NL) use-case description (UCD) (901; also e.g., 410 in FIG. 4, also e.g., 101 in FIG. 1). A use-case development environment (902) may include the functions of a Use-Case Text Editor (904; also e.g., 202 in FIG. 2), an NL Text-Analysis Engine (905, also e.g., 408 in FIG. 4), a schema and representation for the application model (908; also e.g., shown in FIG. 3), and an Application Model Analyzer (906; also e.g., 702 in FIG. 7). The input NL Use-Case Description (901) is represented in the text editor (904), which can be used to produce an edited NL UCD text (907). An edited NL UCD Text (907) is provided to the NL Text Analysis Engine (905). Alternatively, the unedited NL Use-Case Description (901) may be provided to the NL Text Analysis Engine (905) without being edited. The NL Text Analysis Engine (905) produces an application model (908; also 412 in FIG. 4 and 701 in FIG. 7). The application model (908) is provided to the Application Model Analyzer (906), which produces Feedback (903). This feedback can take the form of reports or of messages (as shown by 707 and 708 in FIG. 7) or others. The Feedback (903) may be made available within the UDE (902).

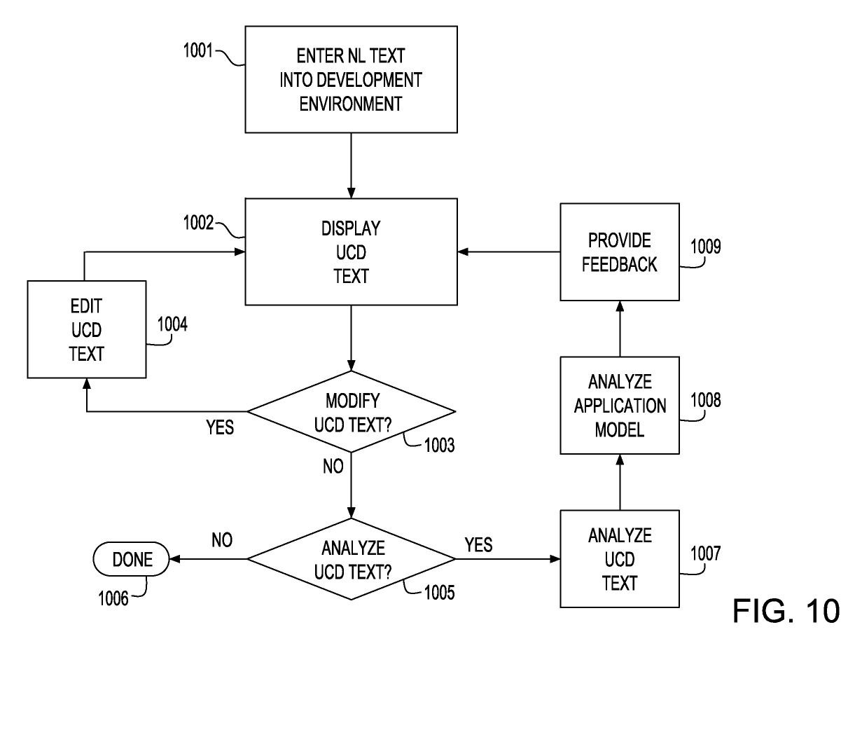

In one embodiment, the iterative refinement may be performed interactively with a computer processor executing, for example, the components shown in FIG. 9, and a person acting in the role of a use-case author or the like or another. FIG. 10 illustrates an example of interactive method employed for iterative refinement of a use case. A textual use-case description is entered into a use-case development environment (1001). The text may be entered by any means, such as by directly typing or by copying from another electronic document, or by reading from a file, downloading from another device, or by other means. The text of the use-case description is displayed for review by the use-case author (1002). The author can decide to modify the text or not (1003). If the author decides to modify the text, then they edit the text (1004) and the edited text is displayed (1002). If the use case is edited, the purpose of the editing may be to improve the quality of the UCD in some respect. The cycle of reviewing and editing may happen repeatedly. If or when the author decides not to modify the text any further, the author may decide to analyze the UCD text or not (1005). If the author decides not to analyze the text, then the method is done (1006). If the author decides to analyze the text, then the UCD text is analyzed (1007). This analysis is performed according to the natural-language text-analysis Engine, for example, as discussed above and described in FIG. 4. The natural-language text-analysis engine produces an “application model”, for example, as shown in FIG. 4. The UCD Model is then analyzed (1008). This analysis may be performed according to the method described above and shown in FIG. 8. Analysis of the UCD Model produces feedbacks (1009) in the form of reports or messages or annotations or others (e.g., as shown in FIG. 7), which may be provided to the use-case author. The use-case author can then review the UCD text in light of the provided feedbacks and reiterate the process from that point. The overall process may be reiterated multiple times.

A method and system described above, for example, provide for incremental improvement of natural language textual Use-Case Descriptions. Generally, the method and system automatically may create an application model of one or more use cases by automated analysis of use-case texts, automatically analyze the application models of one or more use cases to identify errors and other properties that occur in the use-case texts. The method and system also may provide support for iterative development and incremental improvement of use-case texts.

Creating the application models of one or more use cases may include one or more following steps: identifying a plurality of use-case concepts from the output of a shallow parser that parses textual descriptions of use cases; identifying and recording linguistic and grammatical properties of the use-case texts; classifying the identified concepts based on a knowledge base; building relationships between the classified concepts using heuristics rules; modeling a process flow using the identified concepts and constructed relationships; and creating application models that represent the identified concepts, properties, relationships, and flows and relating these to elements in the original use-case texts.

Identifying a plurality of concepts may further includes one or more following steps: scanning the output of a shallow parser to identify a plurality of actor candidates, including both human and automated actors; scanning the output of a shallow parser to identify a plurality of action candidates; and scanning the output of a shallow parser to identify a plurality of entity candidates.

The identified and recorded properties of use case text may include, but not limited to, one or more or combinations of sentence boundaries, clause boundaries, verb tense and number, voice of sentences.

Classifying the identified concepts based on a knowledge base may be performed based on context and semantic information. The classifying step may include, but not limited to, one or more following steps: using a dictionary for known actions in a use case description; marking text in said textual description based on syntactic match; identifying a role of the marked text from the output of a shallow parser; and assigning a semantic classification based on the role and the syntactic match.

Building relationships between the classified concepts may include using heuristic rules to identify actors who participate in actions, identify entities that participate in actions, or identify the roles of actors and entities in relation to actions, or combinations thereof. Building relationships between the classified concepts also may include using heuristic rules to identify containment and association relationships among identified entities.

Modeling of process flows may include, but is not limited to, the identification and ordering one or more or combinations of sequences of actions, conditional actions, concurrent actions, included sequences of actions. Modeling of process flows also may include the characterization of actions and flows as one or more or combinations of mandatory actions and flows, optional actions and flows, normal actions, exceptional actions.

Automatic analysis of the application model of a use-case text may also include analysis of individual use case models (“intra-use case analysis”), analysis of multiple use case models in relation to one another (“inter-use case analysis”), analysis of one or more use-case models in relation to other models or information (“inter-model analysis”). Automatic analysis of the application model of a use-case text also may include, but not limited to, analysis for one or more or combinations of the following: stylistic properties, size and complexity properties, completeness properties, integrity properties, concurrency properties, data flow properties, control flow properties, access properties.

The stylistic properties may be based on considerations that may include, but not limited to, one or more or combinations of the following: use of passive voice, parallelized constructions, e.g., of actions, actors, entities, and conditions, use of synonyms and acronyms for actors and entities.

The size and complexity properties may be based on considerations that may include, but not limited to, one or more or combinations of the following: the number of use cases in a collection of related use cases, the number of actors in a collection of related use cases, the number of entities in a collection of related use cases, the number of actors in an individual use case, the number of entities in an individual use case, the number of statements in an individual use case, the number of actions in a statement, the number of actors in a statement, the number of entities in a statement.

The completeness properties may be based on considerations that may include, but not limited to, one or more or combinations of the following: presence or absence of use cases, presence or absence of statements, presence or absence of actors, presence or absence of actions, presence or absence of entities, completeness of relationships between actors, actions, and entities, completeness of relationships between use cases, completeness of relationships between use cases and actors, actions, and entities.

The integrity properties may be based on considerations that may include, but not limited to, one or more or combinations of the following: referential integrity, mutually consistent reciprocal relationships, mutually consistent containment and inclusion relationships, mutually consistent specialization and generalization relationships, semantic integrity of actions, actors and entities.

The concurrency properties may be based on considerations that may include, but not limited to, one or more or combinations of the following: the presence or absence of potentially concurrent actions, the possible interference of potentially concurrent actions with respect to access to entities and data, behavior with respect to initiation, progress, and termination.

The data flow properties may be based on considerations that may include, but not limited to, patterns of actions that create, delete, define, and reference data items or other entities. The control flow properties may be based on considerations that may be based on considerations that may include, but not limited to, one or more or combinations of the following: patterns related to sequential, conditional, alternative, and other forms of control flow within a use case; patterns related to control flow as related to the invocation, inclusion, and other use of one use case by another. The access properties may be based on considerations that may be based on considerations that may include, but not limited to, one or more or combinations of the following: actual or potential use of entities by actors, actual or potential references to entities by use cases.

Providing support for iterative development and incremental improvement of use-case texts may includes providing the capabilities to do one or more or combinations of the following, but not limited to only those: create and edit an on-line representation of use-case texts; automatically create application models of use case texts; automatically analyze application models; automatically provide the analysis results. Those operations may be exercised or performed repeatedly until, for example, the use case satisfies applicable quality standards and/or the use case author is satisfied with the quality of the use case.

Automatic creation of application models, automatic analysis of application models, and automatic provision of analysis results may occur in any of the following ways: upon editing of the use-case text, upon saving of the use-case text, according to a schedule, in response to a user request, in response to other events or conditions.

Provision of analysis results may be accomplished by annotating and otherwise marking the occurrence of problems in the use-case text.

system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

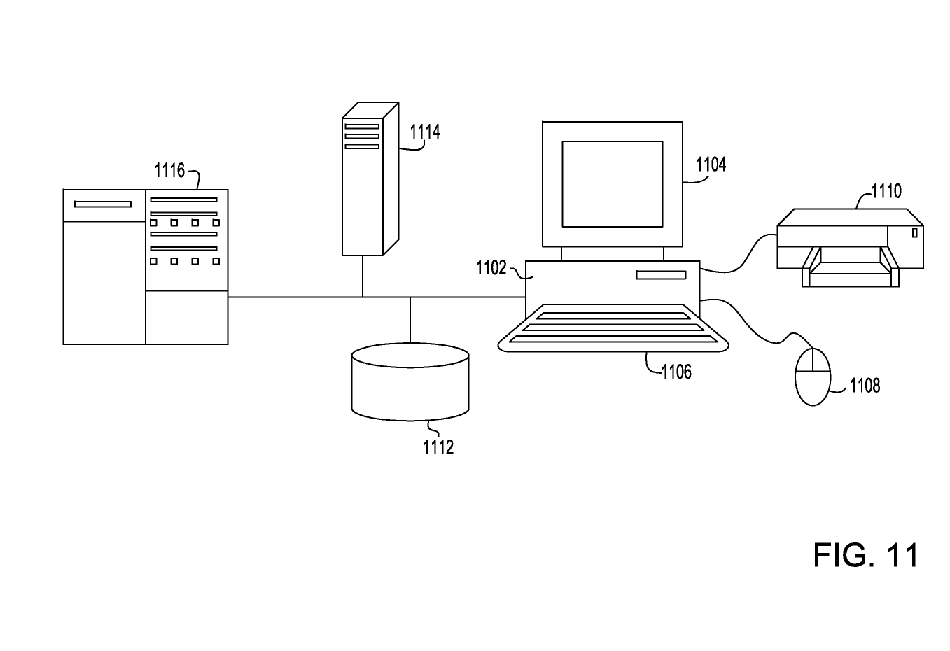

Referring now to FIG. 11, the systems and methodologies of the present disclosure may be carried out or executed in a computer system that includes a processing unit 1102, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit 1102 by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen 1104 for presenting output displays and providing a display through which the user may input data and interact with the processing system, for instance, in cooperation with input devices such as the keyboard 1106 and mouse device 1108 or pointing device. The computer processing system may be also connected or coupled to one or more peripheral devices such as the printer 1110, scanner (not shown), speaker, and any other devices, directly or via remote connections. The computer processing system may be connected or coupled to one or more other processing systems such as a server 1110, other remote computer processing system 1114, network storage devices 1112, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems (e.g., 1102, 1114, 1118), or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, or server. A module may be a component of a device, software, program, or system that implements some “functionality”, which can be embodied as software, hardware, firmware, electronic circuitry, or the like. Such module may be capable of causing a functional change in the computer.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for identifying modeling errors in textual use case description, comprising:
analyzing by a processor an input text describing a use case; and
creating an application model representing the use case, the application model containing information obtained from analyzing the input text describing the use case.

2. The method of claim 1, further including:
analyzing using an automatic process the application model.

3. The method of claim 2, further including:
identifying one or more errors occurring in the input text in response to results obtained in the analyzing step.

4. The method of claim 2, further including:
creating a report summarizing the information in the application model.

5. The method of claim 3, further including:
repeating the steps of analyzing an input text, creating an application model, analyzing the application model, and identifying one or more errors, in response to receiving one or more updates to the input text.

6. The method of claim 1, wherein the step of creating an application model includes:
identifying a plurality of use-case concepts from output of a shallow parser that parses the input text describing a use case;
identifying and recording linguistic and grammatical properties of the input text describing a use case;
classifying the identified use-case concepts based on a knowledge base;
building relationships between the classified use-case concepts using heuristics rules;
modeling a process flow using the identified concepts and the built relationships; and
creating application models that represent the identified use-case concepts, the linguistic and grammatical properties, the built relationships, and modeled process flow and to relate to one or more elements the input text.

7. The method of claim 6, wherein the step identifying a plurality of use-case concepts includes:
scanning output of a shallow parser to identify a plurality of actor candidates, including both human and automated actors;
scanning the output of a shallow parser to identify a plurality of action candidates; and
scanning the output of a shallow parser to identify a plurality of entity candidates.

8. The method of claim 6, wherein the identified and recorded linguistic and grammatical properties include sentence boundaries, clause boundaries, verb tense and number, or voice of sentences, or combinations thereof.

9. The method of claim 2, wherein the step of analyzing the application model includes analysis of stylistic properties, size and complexity properties, completeness properties, integrity properties, concurrency properties, data flow properties, control flow properties, or access properties, or combinations thereof.

10. The method of claim 1, further including:
executing a text editor for receiving the input text and one or more updates to the input text.

11. The method of claim 1, wherein the steps of analyzing and creating are performed automatically during a process of a user creating a use case description.

12. A system for identifying modeling errors in textual use case description, comprising:
a processor; and
a text analysis module operable to analyze an input text describing a use case and further operable to create an application model representing the use case, the application model containing information obtained from analyzing the input text describing the use case.

13. The system of claim 12, further including:
a model analyzer module operable to analyze the application model and identify one or more errors in the use case.

14. The system of claim 13, wherein the model analyzer module further includes:
a report generator operable to generate one or more reports containing information associated with the use case.

15. The system of claim 13, wherein the model analyzer module further includes:
a rule evaluator operable to evaluate information in the application model using one or more rules.

16. The system of claim 13, further including:
a text editor operable to receiving the input text.

17. The system of claim 16, wherein the text analysis module, model analyzer module, and text editor are integrated as a use case development environment.

18. A program storage device readable by a machine, tangibly embodying a program of instructions executable by the machine to perform a method of identifying modeling errors in textual use case description, comprising:
analyzing by a processor an input text describing a use case; and
creating an application model representing the use case, the application model containing information obtained from analyzing the input text describing the use case.

19. The program storage device of claim 18, further including:
analyzing using an automatic process the application model.

20. The program storage device of claim 19, further including:
identifying one or more errors occurring in the input text in response to results obtained in the analyzing step.

21. The program storage device of claim 19, further including:
creating a report summarizing the information in the application model.

22. The program storage device of claim 20, further including:
repeating the steps of analyzing an input text, creating an application model, analyzing the application model, and identifying one or more errors, in response to receiving one or more updates to the input text.
